(19) United States
(12) Patent Application Publication
(10) Pub. No.: US 2006/0165053 A1
(43) Pub. Date: Jul. 27, 2006

(54) Content based data packet routing using labels

(75) Inventors: Sudeept Bhatnagar, Plainsboro, NJ (US); Samrat Ganguly, Monmouth Junction, NJ (US); Rauf Izmailov, Plainsboro, NJ (US); Yasuhiro Miyao, Kawasaki (JP)

Correspondence Address: NEC LABORATORIES AMERICA, INC., 4 INDEPENDENCE WAY, PRINCETON, NJ, 08540, US

(73) Assignee: NEC Laboratories America, Inc., Princeton, NJ (US)

(21) Appl. No.: 11/040,849

(22) Filed: Jan. 21, 2005

(51) Int. Cl. H04L 12/28

(52) U.S. Cl. 370/351

(57) ABSTRACT

Disclosed is a content based router, system and method of operation. Upon receipt of a data packet at in ingress router, the ingress router matches the content of the data packet against stored user subscriptions. In one embodiment, the content is described using XML data and the user subscriptions are defined by XML queries. The router assigns a routing label to the data packet based on the matching, and transmits the data packet to a second network router. Intermediate routers along the packets path then use the assigned label in combination with stored routing tables in order to determine next hop routing. Upon receipt at an egress router, the content of the message is matched against user subscriptions for those users serviced by the egress router, and the egress router provides the data packet to those end users whose subscriptions match the content. The assigned routing labels may define routing paths or routing trees.

### BACKGROUND OF THE INVENTION

The present invention relates generally to data networking, and more particularly to content based data packet routing.

Convention routing of data packets in an internet protocol (IP) network is well known. In typical IP routing, a data packet contains a destination address which is the IP address of the ultimate intended destination of the data packet. When a data packet arrives at a network router, the router determines the next router on the path (i.e., the next hop) based on the packet's destination address, and transmits the packet to the next router. One particular type of IP routing uses routing tables to determine a packet's next hop. A routing table contains a list of IP addresses (or more likely IP address ranges) and an associated next hop for each of the IP address ranges. When a data packet is received, the routing table matches the destination address to an appropriate IP address range in its routing table, and transmits the data packet to the next hop as identified in the routing table. The routing table address ranges are often represented as IP address prefixes, and one technique for matching IP packet destination addresses to these IP address prefixes is called longest prefix matching. Routing data packets to their destination address in general, and longest prefix matching in particular, are both well known in the art of data networking.

Another type of routing is referred to herein as content based routing, wherein a data packet is routed based on its content, rather than a pre-specified particular destination address. This type of routing is useful in publish/subscribe systems in which users may subscribe to certain types of information, while content providers publish the information to the network. This type of system allows users to define the type of information they are interested in by subscribing to particular content. Content providers then publish their content to the network without any particular indication as to which users are to receive the content. By matching user subscriptions with content provider publications, content is disseminated through the network and users receive only the content to which they have subscribed.

Filtering and routing content to appropriate users is a complex task, which, in one known implementation, is performed by application level network routers which are organized into an overlay network. An overlay network is a virtual network fabric that is implemented by application level routers that communicate with each other and end user clients using existing underlying IP network infrastructure. Overlay networks typically use the reliable point-to-point communication protocols (e.g., TCP) of the underlying network in order to implement some additional feature or service. The overlay network service is provided independent of the underlying network. In a content based overlay network, the content based services are provided in the overlay network, while the underlying network is used for standard point-to-point data communication.

In a content based overlay network, the content based services are implemented by content based routers. When a user subscribes to certain content, that subscription is stored in the routing tables of the content based routers. The routing tables also identify next hop content based routers for the various stored subscriptions. As published content arrives at the routers, the content is matched against the routers' stored subscriptions and the content is transmitted to the appropriate next hop content based router(s). The content based router at which the published content first enters the overlay network is referred to as the ingress router.

In order to implement content based routing, some technique for describing content must be used so that subscriptions may be defined and content may be matched against those descriptions. One such technique is the extensible Markup Language (XML), which is a well known language for describing electronic documents using tags and values associated with the tags. More accurately, XML is actually a metalanguage—a language for describing other languages—which allows for the design of customized markup languages for various different types of documents. XML may be used to store any kind of structured information, and to enclose or encapsulate information in order to pass it between different computing systems which would otherwise be unable to communicate. XML is defined in further detail in Extensible Markup Language (XML) 1.0 (Third Edition), W3C Recommendation 4 Feb. 2004, F. Yergeau, T. Bray, J. Paoli, C. M. Sperberg-McQueen, E. Maler, 2004 W3C, which is incorporated herein by reference.

In an XML implementation of a content based overlay network, the routers may be referred to as XML routers. In such an implementation, each of the XML routers stores subscriptions as XML queries. As content arrives at each of the XML routers, the router must compare the XML description (i.e., metadata) of the arriving content to the stored XML queries. This first requires parsing the XML description to determine its different tags and their values, and then matching the tags and values against the stored XML queries (i.e., user subscriptions). Upon a determination that arriving content matches a user subscription, the XML router transmits the content to a next hop XML router in the overlay network based upon a routing table. This process of receiving content, parsing the XML description and matching it against stored XML queries, and forwarding the content to the next hop XML router, is performed at each of the XML routers in the overlay network until the content is eventually delivered to the subscriber by the last hop (i.e., egress) XML router.

A problem with the above described XML implemented content based overlay network is that it does not scale well to a large number of users and a significant amount of traffic. Parsing XML descriptions and the associated matching of content to user XML queries is slow and computationally intensive. As such, as the number of users and content traffic increases, the content based overlay network may become overloaded and suffer significant performance delays.

Therefore, what is needed is an improved technique for content based routing which scales easily and efficiently for a large number of users.

### BRIEF SUMMARY OF THE INVENTION

The present invention provides advantages over the prior content based routing systems by utilizing label based routing in combination with content based routing. In one embodiment, upon receipt of a data packet at a router, the router matches the content of the data packet against stored user subscriptions. The router assigns a routing label to the data packet based on the matching, and transmits the data packet to a second network router. Intermediate routers along the packet's path use the assigned label in combination with stored routing tables in order to determine next hop routing, rather than performing additional content matching. Upon receipt at an egress router, the content of the message is matched against user subscriptions for those users serviced by the egress router, and the egress router provides the data packet to those end users whose subscriptions match the content. Since the intermediate routers do not need to perform any content matching in order to route the message, the content based routing in accordance with the present invention is faster and more efficient than prior techniques.

In one embodiment, the data packets include XML data which describes the content of the data packets, and the user subscriptions are defined by XML queries. The matching of the data packet content against the user subscriptions is performed by first parsing the XML data and then matching the XML data against the XML queries.

There are various alternatives for utilizing routing labels in accordance with the principles of the invention. A routing label assigned to a message may define a single path from an ingress router to an egress router, possibly including one or more intermediate routers. A routing label may also define a routing path from an ingress router to multiple egress routers, possibly including one or more paths through intermediate routers. In addition, multiple labels may be assigned to a single message, which each of the multiple labels defining either a path or a tree.

Label based routing in combination with content based routing provides improved performance because the time consuming and computationally expensive tasks of XML parsing and query evaluation are not performed in the intermediate routers. Label based routing in combination with content based routing also allows for other benefits as well. For example, the data packet contents may be compressed at the ingress router and transmitted through the intermediate routers in compressed form. Since the routing is pre-defined by the labels, the content itself is not needed in the intermediate routers, and the content only needs to be decompressed at the egress router so that it may be forwarded to appropriate subscribers.

These and other advantages of the invention will be apparent to those of ordinary skill in the art by reference to the following detailed description and the accompanying drawings.

### BRIEF DESCRIPTION OF THE DRAWINGS

FIG. 1 shows an overlay network in which the content based routing principles of the present invention may be implemented;

FIG. 2 shows a high level block diagram of a network router;

FIG. 3 shows an exemplary subscription table;

FIGS. 4A-4D illustrate routing paths and routing trees; and

FIGS. 5A-5B illustrate routing tables.

### DETAILED DESCRIPTION

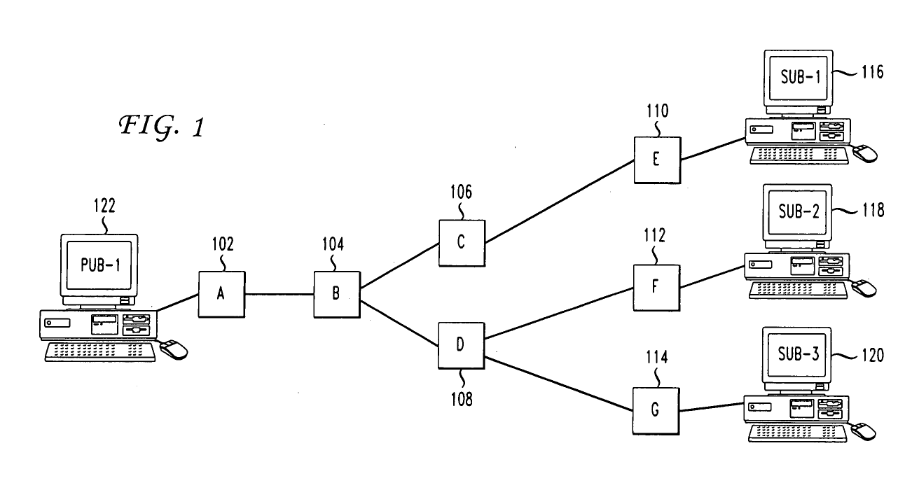

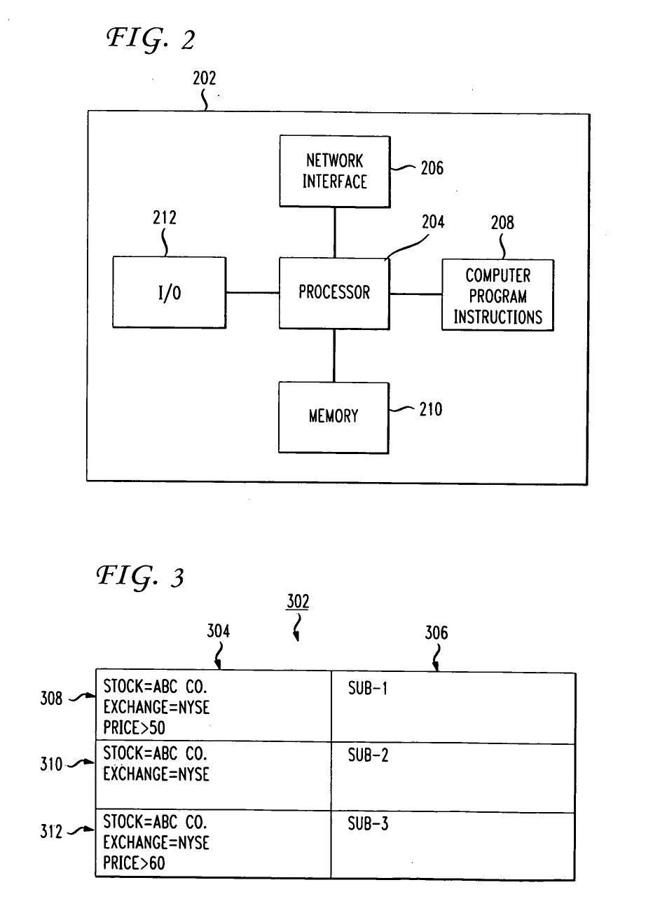

FIG. 1 shows an overlay network in which the content based routing principles of the present invention may be implemented. FIG. 1 shows overlay routers A 102, B 104, C 106, C108, E 110, F 112 and G 114. These routers may be implemented as is well known in the art using, for example, programmable computers. A high level block diagram of a network router is shown in FIG. 2. FIG. 2 shows a network router 202, the functioning of which is controlled by processor 204. Processor 204 executes stored computer program instructions 208 which define the overall operation of router 202. Router 202 also contains memory 210 for storing data and various routing table information as will be described in further detail below. Memory 210 may be any type of computer readable storage medium, such as magnetic, optical, or any other type of storage media. While memory 210 is shown in FIG. 2 as a single unit, memory 210 may be implemented with multiple memory units, with each such memory unit being any appropriate type of storage media. Further, while computer program code 208 is shown as a separate element, computer program code 208 may be stored in any one or more of such memory units. Router 202 also contains a network interface 206 for allowing communication with a data network. Depending upon the particular implementation, network interface 206 may comprise multiple network interfaces for allowing router 202 to send and receive data on multiple ports. Router 202 also contains input/output 212, which represents input/output devices (e.g., keyboard, mouse, display, buttons, speakers, etc.) which allow for user interaction with router 202. One skilled in the art will recognize that a typical network router would also contain other well known elements as well and that FIG. 2 is used to describe a high level functional description of router 202. Further, while the above description indicates that the overall functioning of router 202 is controlled by the processor 204 executing computer program instructions, it should be understood that such functioning could be controlled by software, hardware, or any combination of software and hardware.

Returning to FIG. 1, the links between each of the routers represent logical connections in order to illustrate the overlay network defined by the routers and links. These logical connections are not necessarily physical connections, and there may be other network routers (e.g., standard IP routers) or other network nodes between connected routers. Thus, as shown in FIG. 2, a link merely represents that two connected routers may communicate with each other, either directly or using some underlying network connectivity. Also shown in FIG. 1 are end user subscriber computers sub-1 116, sub-2 118 and sub-3 120. These end user subscribers are subscribers to the content based routing services provided by the content based overlay network shown in FIG. 1. Thus, each of the subscribers may subscribe to certain content which the subscriber is interested in and wishes to receive at the subscriber's computer. In accordance with one embodiment of the invention, all subscriptions are stored on router A 102, and all published content is routed through router A 102 for processing. Thus, router A 102 may be considered as an ingress router for published content since router A 102 is the router at which the content enters the overlay network. When subscribers wish to subscribe to some content, their subscriptions (i.e., the definition of the content to which the subscriber is subscribing) are forwarded to, and stored in, router A 102. Such subscriptions are stored in a subscription table in the memory of router A 102.

It is noted that FIG. 1 is used in order to illustrate the principles of the present invention and may not represent a typical actual implementation of an overlay network. For example, given the nature of an overlay network, there would likely be additional network connectivity between various routers (e.g., between router A 102 and router G 114). Further, there would likely be additional end user subscribers associated with the various routers. However, for ease of reference, such additional connectivity and subscribers are not show in FIG. 1. Only those links and subscribers which are used in the following description are shown in FIG. 1.

An exemplary subscription table is illustrated in FIG. 3. FIG. 3 shows subscription table 302 containing fields 304 and 306. Each record in the subscription table 302 represents a subscription, with field 304 containing a description of the subscribed to content, and field 306 identifying the subscriber associated with the subscription. Record 308 shows the subscription for subscriber sub-1 and indicates that subscriber sub-1 has subscribed to financial related content relating to the stock of ABC Co. on the NYSE exchange and having a price >50. This is represented in FIG. 3 as:

STOCK=ABC CO.

EXCHANGE=NYSE

PRICE>50

Similar subscriptions are shown in FIG. 3 for subscriber sub-2 (record 310) and subscriber sub-3 (record 312). It is noted here that in an advantageous embodiment the content routing is performed based on XML processing. As such, the subscriptions shown in field 304 of table 302 would be described in terms of an XML query. As described above, XML is well known in the art, and XML queries representing various content subscriptions could be readily developed by one skilled in the art. Further, while an XML embodiment would be advantageous, there are various other techniques for describing subscriptions which may also be used. As such, and for ease of description, the subscriptions shown in table 302 will use a more general notation as shown.

As described above, all published content is routed through ingress router A 102 for initial processing. Thus, when a publisher, such as pub-1 122 wishes to publish some content, the content will be inserted into the network by initially sending it to router A 102. Again, the link between publisher pub-1 computer 122 and router A 102 is meant to represent a logical connection and not necessarily a physical connection. Thus, content published from pub-1 122 may be routed through additional network nodes prior to arriving at router A 102.

In exemplary operation, suppose that pub-1 122 publishes content having the following content description:

STOCK=ABC CO.

EXCHANGE=NYSE

PRICE=20

Again, in an XML embodiment, the published content would be described by standard XML tags and attributes, but for ease of description published content is described herein using a more general notation as shown. Upon receipt of the content by router A 102, the content must be parsed and matched against the subscriptions in subscription table 302. While XML parsing and matching techniques are well known in the art, such processing is time consuming and computation intensive. In prior art techniques, after router A 102 parses and matches content to subscriptions, router A 102 transmits the content to one or more additional routers in the overlay network, at which point each of those additional routers performs the same parsing and matching, and such parsing and matching occurs at each content based router until the content is delivered to the appropriate subscribers. Such prior art processing is very time consuming and therefore such prior art content based routers are not able to scale well to large numbers of subscribers and significant traffic load. In accordance with the present invention, and as will be described in further detail herein, such parsing and matching only takes place at certain routers (e.g., ingress and egress) thereby significantly improving the efficiency of content based routing.

In accordance with an embodiment of the present invention, router A 102 parses and matches the incoming content to the subscriptions in its subscription table. Continuing with the example, the content received from pub-1 122 will match only the subscription in record 310 of subscription table 302. As indicated in field 306 of record 310, this content only needs to be forwarded to subscriber sub-2 118. Router A 102 also stores a list of content based egress routers associated with each of the subscribers. A content based egress router refers to the last content based router in the overlay network to which the content is to be transmitted prior to delivery to a subscriber. For subscriber sub-2 118, the content based egress router is router F 112.

Once the egress router is identified, router A 102 creates a message containing the content, along with a label associated with a predetermined path from router A 102 to router F 112. Thus, the present invention utilizes label based routing within the overlay network in order to improve performance and remove the need for XML parsing and matching at each content based router on the path from the ingress router to the egress router. Label based routing is known in the context of standard IP routing, for example MultiProtocol Label Switching (MPLS), as described in E. Rosen, A. Viswanathan, R. Callon, Multiprotocol Label Switching Architecture, Internet Engineering Task Force (IETF), Request for Comments (RFC) 3031, January 2001, which is incorporated herein by reference. In MPLS, a short fixed-length label is generated that acts as a shorthand representation of an IP packet's header. Subsequent routing decisions (made by label switched routers) are made based on the MPLS label instead of on the original IP address.

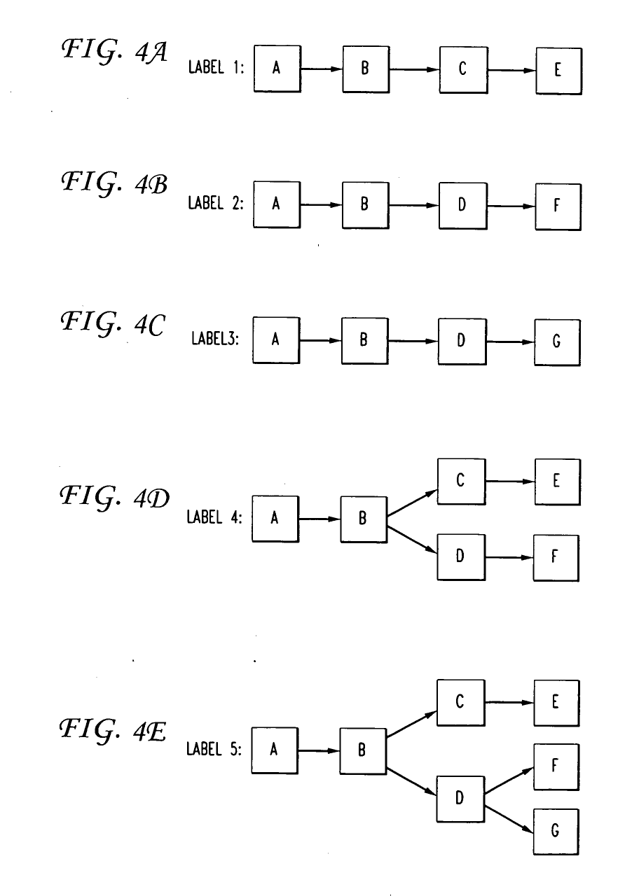

Labels are predefined and define various paths between routers. Exemplary labels, and associated paths are illustrated in FIGS. 4A-4E. Referring to FIG. 4A, label 1 defines a path from router A 102 to router E 110 via router B 104 and router C 106. Referring to FIG. 4B, label 2 defines a path from router A 102 to router F 112 via router B 104 and router D 108. Referring to FIG. 4C, label 3 defines a path from router A 102 to router G 114 via router B 104 and router D 108. In addition to paths, in accordance with one embodiment of the invention, labels may also define multiple paths, or trees. For example, referring to FIG. 4D, label 4 represents a tree having one path from router A 102 to router E 110 via router B 104 and router C 106, and another path from router A 102 to router F 112 via router B 104 and router D 108. Referring to FIG. 4E, label 5 represents a tree having one path from router A 102 to router E 110 via router B 104 and router C 106, another path from router A 102 to router F 112 via router B 104 and router D 108, and another path from router A 102 to router G 114 via router B 104 and router D 108. With respect to these defined paths and trees, it is noted that, for example, there may be a direct connection between router A 102 and router E 110. Even so, it may be desirable to route a message from router A 102 to router E 110 by the path described by FIG. 4A for various reasons. One reason may be load balancing. Another reason may be that there are additional subscribers (not shown in FIG. 1) along the path who are to receive the message (e.g. a subscriber for which router C 106 acts as an egress router with respect to the content based overlay network).

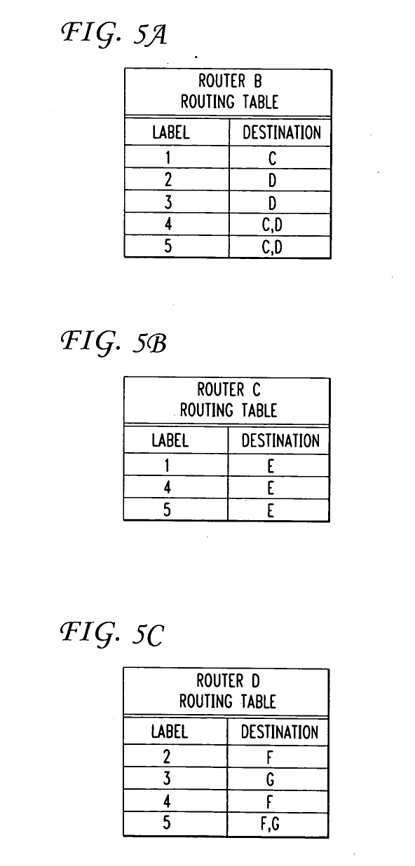

The paths shown in FIGS. 4A-4D are implemented by appropriate label based routing tables stored in each of the overlay routers as shown in FIGS. 5A-5C. FIG. 5A is the routing table which would be stored in router B 104. FIG. 5B is the routing table which would be stored in router C 106. FIG. 5C is the routing table which would be stored in router D 108. Each routing table contains a list of labels along with one or more destination router associated with each of the labels. Thus, upon receipt of a message containing a label, a router will transmit the message to the destination router associated with the label as identified in its routing table. One skilled in the art would recognize that the routing tables shown in FIGS. 5A-5C implement the routing paths and trees of FIGS. 4A-4E.

Continuing now with the above example, wherein pub-1 122 publishes content with the following content:

STOCK=ABC CO.

EXCHANGE=NYSE

PRICE=20

As described above, this content needs to be forwarded to router F 112 so that it may be delivered to subscriber sub-2 118. Upon a determination of egress router F 112 as the destination, ingress router A 102 generates a message containing the published content along with label 2 indicating the path shown in FIG. 4B. Router A 102 transmits this message to router B 104. Upon receipt of the message with label 2, router B 104 looks up label 2 in its routing table (FIG. 5A), determines that this message should be forwarded to router D 108, and then transmits the message to router D 108. Upon receipt of the message with label 2, router D 108 looks up label 2 in its routing table (FIG. 5C), determines that this message should be forwarded to router F 112, and then transmits the message to router F 112.

Upon receipt of the message at egress router F 112, router F 112 needs to parse and match the content against stored subscriptions. Egress routers only need to store subscriptions for those subscribers which are serviced by the egress router. Thus, in the example shown in FIG. 1, egress router F 112 will only need to store subscriptions for subscriber sub-2 118. Thus, egress router F 112 will store the subscription shown in record 310 of subscription table 302 (FIG. 3). Upon receipt of the message, egress router F 112 will determine that the content matches subscriber sub-2's 118 subscription, and router F 112 will transmit the content to subscriber sub-2 118. In an actual implementation, the egress routers will likely support many subscribers, and would therefore have multiple subscriptions stored in memory.

As another example, now suppose that pub-1 122 publishes content having the following content description:

STOCK=ABC CO.

EXCHANGE=NYSE

PRICE=55

This content will match the subscriptions in both records 308 and 310 of subscription table 302. As indicated in field 306 of records 308 and 310, this content needs to be forwarded to subscribers sub-1 116 and sub-2 118. As shown in FIG. 1, the egress router for subscriber sub-1 116 is router E 110, and the egress router for subscriber sub-2 118 is router F 112.

Upon a determination of egress routers E 110 and F 112 as the destinations, ingress router A 102 generates a message containing the published content along with two labels. The message includes label 1 indicating the path to egress router E 110 as shown in FIG. 4A, and the message also includes label 2 indicating the path to egress router F 112 as shown in FIG. 4B. Router A 102 transmits this message to router B 104. Upon receipt of the message with labels 1 and 2, router B 104 looks up the labels in its routing table (FIG. 5A), determines that this message should be forwarded to routers C 106 and D 108, and then transmits the message to routers C 106 and D 108. Upon receipt of the message with label 1, router C 106 looks up label 1 in its routing table (FIG. 5B), determines that this message should be forwarded to router E 110, and then transmits the message to router E 110. Upon receipt of the message with label 2, router D 108 looks up label 2 in its routing-table (FIG. 5C), determines that this message should be forwarded to router F 112, and then transmits the message to router F 112.

Upon receipt of the message at egress router E 110, router E 110 will parse and match the content against stored subscriptions as described above and determine that the message should be forwarded to subscriber sub-1 116. Upon receipt of the message at egress router F 112, router F 112 will parse and match the content against stored subscriptions as described above and determine that the message should be forwarded to subscriber sub-2 118.

As described, an implementation of the present invention utilizes multiple labels with a single message in order to route the content of the message to multiple egress routers, and thus multiple subscribers. In an alternate embodiment, rather than using multiple labels associated with a single message, a single label may be used, where that single label defines a routing tree rather than a single path. For example, returning to the above example in which pub-1 122 publishes content having the following content description:

STOCK=ABC CO.

EXCHANGE=NYSE

PRICE=55

As described above, this matches the subscriptions in both records 308 and 310 of subscription table 302 and needs to be forwarded to subscribers sub-1 116 and sub-2 118 via egress routers E 110 and F 112 respectively.

Instead of ingress router A 102 generating a message containing the published content along with two labels, ingress router A 102 generates a message containing the published content along with a single label (label 4) defining a routing tree as illustrated in FIG. 4D. Router A 102 transmits this message to router B 104. Upon receipt of the message with label 4, router B 104 looks up the label in its routing table (FIG. 5A), determines that this message should be forwarded to routers C 106 and D 108, and then transmits the message to routers C 106 and D 108. Upon receipt of the message with label 4, router C 106 looks up label 4 in its routing table (FIG. 5B), determines that this message should be forwarded to router E 110, and then transmits the message to router E 110. Upon receipt of the message with label 4, router D 108 looks up label 4 in its routing table (FIG. 5C), determines that this message should be forwarded to router F 112, and then transmits the message to router F 112. Processing at egress routers E 110 and F 112 proceed as described above.

As another example, now suppose that pub-1 122 publishes content having the following content description:

STOCK=ABC CO.

EXCHANGE=NYSE

PRICE=65

This content will match the subscriptions in all of records 308, 310 and 312 of subscription table 302. As indicated in field 306 of records 308, 310 and 312, this content needs to be forwarded to subscribers sub-1 116, sub-2 118 and sub-3 120. As shown in FIG. 1, the egress router for subscriber sub-1 116 is router E 110, the egress router for subscriber sub-2 118 is router F 112 and the egress router for subscriber sub-3 120 is router G 114.

Upon a determination of egress routers E 110, F 112 and G 114 as the destinations, there are two alternative techniques for forwarding the message. In the first technique, ingress router A 102 will generate a message containing the published content along with three labels: label 1, label 2 and label 3. Label 1 indicates the path to egress router E 110 as shown in FIG. 4A, label 2 indicates the path to egress router F 112 as shown in FIG. 4B and label 3 indicates the path to egress router G 114 as shown in FIG. 4C. In accordance with the other alternative, ingress router A 102 will generate a message containing the published content along with a single label: label 5. Label 5 defines a routing tree as illustrated in FIG. 4E, such that the message labeled with label 5 will be routed to egress routers E 110, F 112 and G 120. Processing at the egress routers proceeds as described above.

The present invention provides advantages over the prior art content based routing schemes. By utilizing label based routing in combination with content based routing, the present invention provides for an improved content based routing system. In accordance with an advantage of the invention, parsing the content and matching the content against subscriptions is only performed at ingress and egress routers. Intermediate routers save time by routing based on assigned labels.

A system implemented in accordance with the principles of the present invention also allows for additional advantages. For example, since the intermediate routers route based on a label, and not on the content, the content may be compressed at the ingress router and decompressed at the egress router, thus reducing the bandwidth required to route the message. Implementing compression in the prior techniques which parsed the message content and performed subscription matching at the intermediate content based routers would be very inefficient. In order to implement compression in the prior techniques, each router along a path must decompress the message, parse it, match the message's content against its stored subscriptions, perform a routing table lookup to identify the interested destinations, and compress the message before sending it to the identified destinations.

One skilled in the art will recognize that there are various alternative embodiments of the invention described herein. For example, the multiple labels assigned to a single message may each be associated with a single path, a tree, or any combination of single paths and trees.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention. For example, while the above described embodiments were described in connection with overlay networks, it should be recognized that the principles of the present invention may be implemented in other types of networks as well. For example, the principles of the present invention may be implemented in a conventional network in which the content based routers communicate with each other directly rather than being configured as an overlay network.

1. A method for content based network routing comprising the steps of:
receiving a data packet comprising content at a first network router;
matching said content to stored user subscriptions;
assigning a routing label to said packet based on said matching; and
transmitting said data packet to a second network router.

2. The method of claim 1 wherein said step of assigning comprises the step of:
assigning multiple routing labels to said data packet.

3. The method of claim 1 wherein:
said data packet comprises XML data describing said content; and
said user subscriptions are defined by XML queries.

4. The method of claim 3 wherein said step of matching further comprises the step of:
matching said XML data against said XML queries.

5. The method of claim 1 wherein said routing label defines a routing tree.

6. The method of claim 1 wherein said routing label defines a routing path.

7. The method of claim 1 further comprising the step of:
compressing said content of said data packet.

8. A content based network router comprising:
means for receiving a data packet comprising content at a first network router;
means for matching said content to stored user subscriptions;
means for assigning a routing label to said packet based on said matching; and
means for transmitting said data packet to a second network router.

9. The content based router of claim 8 wherein said means for assigning comprises:
means for assigning multiple routing labels to said data packet.

10. The content based router of claim 8 wherein:
said data packet comprises XML data describing said content; and
said user subscriptions are defined by XML queries.

11. The content based router of claim 10 wherein said means for matching further comprises:
means for matching said XML data against said XML queries.

12. The content based router of claim 8 wherein said routing label defines a routing tree.

13. The content based router of claim 8 wherein said routing label defines a routing path.

14. The content based router of claim 8 further comprising:
means for compressing said content of said data packet.

15. A content based network router comprising:
at least one interface for receiving data packets, said data packets comprising content;
stored user subscriptions;
a processor for matching said content of said data packets to said stored user subscriptions and assigning routing labels to said data packets based on said matching; and
at least one interface for transmitting said data packets to a second network router.

16. The content based network router of claim 15 wherein:
said received data packets comprise XML data describing said content; and
said user subscriptions comprise XML queries.

17. The content based network router of claim 15 wherein said routing labels define routing trees.

18. The content based network router of claim 15 wherein said routing labels define routing paths.

19. A content based overlay network comprising:
an ingress router comprising:
at least one interface for receiving data packets, said data packets comprising content;
stored user subscriptions;
means for matching said content to said stored user subscriptions and assigning routing labels to said data packets based on said matching; and
at least one interface for transmitting said data packets to intermediate routers;
at least one intermediate router comprising:
at least one interface for receiving said data packets;
a stored label-based routing table; and
at least one interface for transmitting said data packets to another network router based on said labels.

20. The content based overlay network of claim 19 further comprising:
an egress router comprising:
at least one interface for receiving said data packets from an intermediate router;
stored user subscriptions;
means for matching the content of said data packets to said stored user subscriptions; and
at least one interface for transmitting said data packets to users based on said matching.

21. The content based overlay network of claim 19 wherein:
said data packets comprise XML data describing said content; and
said user subscriptions are defined by XML queries.

22. The content based overlay network of claim 19 wherein said routing labels define routing trees.

23. The content based overlay network of claim 19 wherein said routing labels define routing paths.
